(19) United States
(12) Patent Application Publication
(10) Pub. No.: US 2011/0321010 A1
(43) Pub. Date: Dec. 29, 2011

(54) WEB APPLICATION FRAMEWORK BASED ON OBJECT ORIENTED CLASS MAPPING

(76) Inventor: Yifei Wang, Lisle, IL (US)

(21) Appl. No.: 13/168,847

(22) Filed: Jun. 24, 2011

Related U.S. Application Data
(60) Provisional application No. 61/358,410, filed on Jun. 24, 2010.

(51) Int. Cl. G06F 9/44

(52) U.S. Cl. 717/116

(57) ABSTRACT

A method and system for building a web application framework is provided. This framework explicitly maps each dynamic web page to a class method, called “web service” method. Each MIME type of static web pages is implicitly mapped to a predefined web service method of a system class. All related web service methods are grouped into one object class, in which a business unit of coupled dynamic web pages is bind together to construct a natural web user session implicitly. Each web service class is logically divided into four segments, which is described by a paradigm, called “STUD” (acronym for Services, Templates, Utilities and Data). A new data exchange format, called “SDON” (acronym for Simple Data Object Notation), is defined to represent a structured data exchanged between web client and web server or passed among web servers. A SDON data string can be directly reflected into an object of the data class type. Each data source related to a relational database is mapped to a three tier structure of classes (schema, table, and data record). The data record classes inherit the names of tables inside the database.

This application is based on and claims priority from a Provisional Application Ser. No. 61/358,410 filed on Jun. 24, 2010.

### BACKGROUND OF THE INVENTION

1. Technical Field

The present invention relates generally to the web application framework. More particularly, the present invention relates to a software system to execute web application packages.

2. Description of the Related Art

A core technique of a web application framework is the method of generating dynamic web pages based on end-user input and system environment parameters. Web application frameworks typically provide core functionality common to most web applications, such as user session management, data persistence, template system, and data exchange mechanism between web server and HTTP clients. The value of a web application framework largely depends on two factors: (a) how to reduce web developer's workload for pursuing a high productivity, and (b) how to provide a web deployment environment of a high quality on reliability, performance, scalability and security.

Historically, a CGI (acronym for Common Gateway Interface) approach was first used to create a dynamic web page. Each dynamic web page requires a separate CGI program (a standalone application) to be executed by the web server. The CGI program could be written in any programming language like Perl, C/C++, Java, VB, C# etc. The traditional CGI bottle neck is that the repeat of CGI program process creation downgrades web server performance. The later on FastCGI technique improves the web server performance by preserving the execution content of each CGI program.

Second category of web application frameworks is to define a dynamic web page by a HTML skeleton plus embed dynamic components which are coded by a set of language specific APIs. Therefore, major web application frameworks (e.g., ASP.NET, JSP/J2EE, PHP, Coldfusion etc.) described below, have their own API definitions.

ASP.NET is a web application framework developed and marketed by Microsoft on its product IIS (Internet Information Server). In ASP.NET, each dynamic web page is defined by a file with an “.aspx” extension (for example, MyPage.aspx). The server-side script tag is defined in a code file with names like MyPage.aspx.cs or MyPage.aspx.vb. These codes are based on either C# language or visual Basic language.

PHP (Hypertext Preprocessor) is a widely used, general-purpose scripting language designed for the development of dynamic web pages. Each dynamic web page is defined by a file with a “.php” extension (for example, MyPage.php). The PHP file contains PHP codes by using the common delimiter “<?php” to open a PHP section and “?>” to close a PHP section.

JSP/J2EE is a Java-based web application framework developed by Sun Microsystems. In J2EE, each dynamic web page is defined by a file with a “.jsp” extension (for example, MyPage.jsp). The JSP page mixes the standard HTML or the XML element with some scriptlet elements, which are the delimited blocks of Java code. During the web page request processing, each JSP page is translated into one Java Servlet class.

There are other web application frameworks like ColdFusion etc. The main difference among the web application frameworks of this category is that they introduce a different programming language (Compiled or Scripting) to code the embed sections inside a HTML skeleton file. These server-side script languages are VB script, PHP, JSP script, Groovy, Ruby, Scala, Python, JSF or so on.

For web application framework, web session management is the next core function. Since a business process in a web application normally needs to go through multiple dynamic web pages, and a dynamic web page is most likely related to the end user identification by running a web browser, but HTTP is a stateless protocol, therefore a web session object out of HTTP is used to glue these web pages together with the association of the end user ID. The session definition, session management and session object storage varies in different web framework technologies. Web session management has a critical effect on the web framework performance.

For example, an ASP.NET page includes a session variable inside its code section through the Session property of the Page object, e.g., Session(“Stocks”)=“MSFT; GE”; PHP uses a global associative array $_SESSION to store the session data, e.g., $_SESSION[stock]=“GE”; JSP/J2EE web applications have four session scopes: (Page, Request, Session, and Application). Each of J2EE session scopes has a context in which primitive data and object references can be stored for use by other components that share the same context. The J2EE page session is set via a Session object (e.g., Session.setAttribute(“stocks”,“MSFT; GE”)). All above web application frameworks share a same idea on session management, that is, that a web framework has a centralized session object cache, therefore each dynamic web page retrieves and stores its session variable name/value pairs by the SET/GET operations. The present invention provides a new definition of dynamic web page by an object oriented class mapping technique. Also, a new definition of web session in the present invention makes the session management implicitly distributed inside the cache objects. Therefore, the fulfillment steps of web requests become less in the web framework of this invention.

There is a third category of web application frameworks based on a so called MVC (Model-View-Control) architectural pattern. For example, they are Structs/Structs2, Grails, Ruby on Rail etc. The view is the HTML or XHTML skeleton. The controller receives GET or POST input and decides what to do with it. The model is the domain objects, which contain the business rules and data access objects. The MVC popularity in web framework design origins from it's being adapted in JSP/J2EE system. JSP/J2EE uses a JSP file to represent the view, an extending HttpServlet class to implement the controller, and a plain old Java class or Java Beans to materialize the model. Although the MVC architecture of web framework helps the clearness and organization of web development, it does not provide any new core function from the second category of web frameworks. The present invention provides a new organization paradigm of dynamic web page code instead of MVC system pattern.

Another core function of web application framework is the data exchange mechanism between web server and HTTP clients or among web servers. HTTP protocol specifies a query string, which is the part of URL (Uniform Resource Locator), to pass the simple data from HTTP client to web server. Generally, to submit a structured data to web server, a XML-based data format (e.g., SOAP message) is used in HTTP POST request. As a low-overhead alternative to XML, JSON (acronym for JavaScript Object Notation) format is promoted to transmit data between a web server and web client. Although JSON is a language-independent data format, it is derived from JavaScript scripting language, web browsers could use an XMLHttpRequest or JSONRequest to request an data in JSON format from web server. Then, the JSON text can easily be converted into a JavaScript value, which makes it very convenient to be used with JavaScript. For its lack of semantics, a JSON text to be executed by JavaScript interpreter poses several security concerns.

In order to unify data exchange between web server and web client or among web servers in any direction, the present invention represents a new data object text format, so called “SDON” (acronym for Simple Data Object Notation) by adding semantics to the format for itself validation.

Furthermore, another core function of web application framework is to handle the data object persistence in web server. Since most dynamic web page creation needs data retrieval from database and data repositing into database, database could be of XML-type or object-oriented type, but a relational database management system dominates the data storage selection in web development. Therefore, a web application framework based on object oriented language APIs has an immediate challenge on how to persist the data object of web services into a relational database. Any better solution will benefit both web framework performance and web development productivity. PHP provides database access libraries to access database directly via SQL statements. ASP.NET programs could write SQL statements over ODBC library to access database directly. In JSP/J2EE, servlets could access the database directly via JDBC library. But J2EE-based web frameworks provide a set of different and evolutional approaches to access the relational DB more efficiently. For example, they are EJB (Enterprise Java Bean), Hibernate, JPA (Java Persistence API) etc. The present invention provides a three-tier class structure for data object relational mapping, which greatly simplifies the server-side coding.

The patent application US 1999/5991802 presents a method of invoking object general method of class via a shim script. The patent application US 2006/7089561 B1 describes the architecture of a scalable web application framework. The patent application US 2010/0023872 A1 shows an architecture of web page serving with a user-define rule recipe. The patent application US 2007/7254634 B1 presents a technique to manage the user session state across servers on a content delivery network. The patent application US 2009/7487166 B2 describes a method of mapping XML data and document style web services into ontologies.

### SUMMARY OF THE INVENTION

The present invention provides a method and system of building a web application framework based on an object oriented class mapping methodology. This invention covers four key function areas of web framework with four objects.

The first object of the present invention is to map web pages or webs services into class methods as following:

(1) A dynamic web page is represented by a class method with the unique signature of five components (modifier=“public”, return type=“void”, method name=web_page_name, input parameter=“HttpRequest”, output parameter=“HttpResponse”). Here the mapping relationship between the class method name and the exposed web page name is defined in a configuration table inside the server. This type of class method is called “web service” method.

(2) Each mime type of static web pages is mapped to a predefined method of a predefined system class (i.e., FileLoad class). For example, all image files with extension of (.jpg, .gif, .png, .bmp etc.) are mapped to a method called “loadImage” of class “FileLoad”.

(3) A set of dynamic web pages related by a business process are naturally grouped into one class, called “web service” class.

Different from all server scripting technologies like ASP.net, JSP/J2EE, PHP, Python, Coldfusion etc., the web framework of this invention does not need a skeletal web page file to be associated to each dynamic web page. Different from the traditional CGI, the web framework of this invention does not define a set of API to be implemented, but could be implemented in any object oriented language (e.g., Java, C#, etc.).

The second object of the present invention is to manage the user web session by a natural approach. Instead of saving the shared data variables to system Session object, which is external to the web service pages like other web frameworks, this framework of this invention defines web session as following:

(1) A simple web session is implicitly represented by an object of stateful web service class which has the instance variables shared among multiple web service methods. The class object is associated to web end user identification.

(2) An aggregated web session is represented by an object group of several web service classes. All objects in this group have the same web end user ID.

The web framework of this invention always caches all objects of web service classes with customized lifetimes. The concept of implicit embedding web session into web service objects will save web developer coding effort because no setting/getting session variables are needed.

Another side object of the present invention is to promote the web page code readability of web application. A new design paradigm of web service classes is provided in term of “STUD” (acronym for web Services, web Templates, Utilities, session Data), by which the codes of a web service class are organized into those four areas.

The third object of the present invention is to unify all structured data exchange mechanisms between web server and web client or among web servers by defining a new data exchange text format in term of “SDON” (acronym for Simple Data Object Notation). The SDON data object has a simple syntax of “variableName<DataType>={ . . . }”, where the “DataType” excludes these basic data types (String, integer, float, double, Date). Although it looks similar to JSON data format, the semantics of SDON data object makes it more secure in parsing, and enable to be reflected into an object of data class type directly without going through any external validation procedure. Also, SDON data object could be encoded into URL Query string of HTTP GET request too.

The fourth object of the present invention is to enable web services to access a relational database without writing explicit SQL statements. This web framework maps a relational database into a three tier class structure as follows:

(1) Data record tuple of a database table is mapped to a data class inheriting the table name (i.e., class <TABLE NAME>). For example, an object of class CUSTOMERS is a holder of one data record in database table of CUSTOMERS.

(2) Database table itself is mapped to a table class inheriting the table name by appending “_TAB” (i.e., class <TABLE NAME>_TAB). The table class manages the table metadata and keeps the local cache of data record objects by option. The table class object provides a bridge for web services to interact with the database via data objects by five standard methods (i.e., select( ) update( ) delete( ) insert( ) refresh( ). For example, a class CUSTOMERS_TAB is a bridge of table CUSTOMERS.

(3) Database view is mapped to a table class too. But this table class object of view type provides a bridge for web services to query the database only via table class objects by two methods (i.e., select( ) refresh( ).

(4) Data schema is mapped to a schema class inheriting the schema name (i.e., class <SCHEMA NAME>). The schema class manages the database connection pool by the data source and controls DB transaction as well as holds a set of table class objects. But the schema class does not provide any database DDL (Data Definition Language) functions.

For its simplicity, being different from JPA/JDO/EJB specifications, a web application framework of this invention depends on database system capability to enforce the data integrity inside database, and depends on database stored procedure/view function to do a complex query, there is no XML file used for mapping the data object to database table record.

The foregoing has outlined some of the more pertinent features of the present invention. These features should be construed to be merely illustrative. Many other beneficial results can be attained by applying the disclosed invention in a different manner or by modifying the invention as will be described.

### BRIEF DESCRIPTION OF THE DRAWINGS

For a more complete understanding of the present invention and its advantages thereof, reference should be made to the following Detailed Description taken in connection with the accompanying drawings, in which:

FIG. 1 is a system diagram of the web application framework in the present invention which may be implemented;

FIG. 2 illustrates a typical class mapping of a dynamic web page URL;

FIG. 3 illustrates a typical class mapping of a static web page URL;

FIG. 4 illustrates a typical web service stateful class containing multiple dynamic web pages with session variables;

FIG. 5 illustrates an example of the code design pattern (“STUD”) of a web service class (“Shopping”);

FIG. 6 illustrates a typical data access class mapping of a database schema (“blogger”);

FIG. 7 illustrates a typical data object of SDON (an acronym for “Simple Data Object Notation”) format.

### DETAILED DESCRIPTION OF THE INVENTION

The present invention leverages web application framework architecture and functionality such as generally described below. Familiarity with Java, C++, C#, or another object oriented programming language, and JSP/J2EE, ASP.NET, PHP architecture is presumed. Additional information about JSP/J2EE is available from Oracle (Sun Microsystems). Additional information about ASP.NET is available from Microsoft.

By way of background, the internet web relies on the client-server architecture over HTTP protocol. The web client (e.g., browser) initiates a web service by sending a HTTP GET or POST request to a web server. The web server delivers a web page to the web client. The web pages could be of different MIME types (e.g., text/html, text/xml, image/gif, image/jpg). The content of web page could be generated dynamically based on web client request or directly loaded from a static file (e.g., image file). This is referred to as dynamic and static web page respectively. There are two kinds of dynamic web pages, which depends on whether the dynamic content is related to the web client user identification or not. For example, a web calculator service will not depend on the end user identification, but on the input parameters of HTTP request; a web shopping process will go through multiple web services which depend on the end user identification. The multiple web services of a shopping process construct a web session.

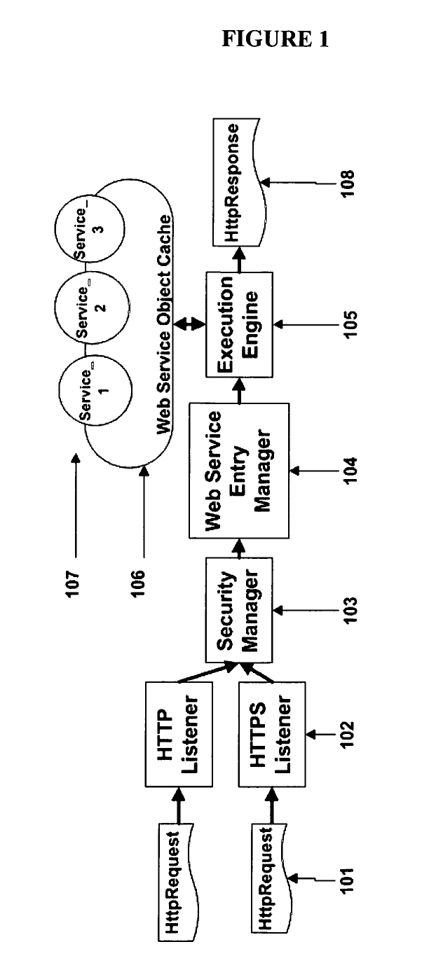

FIG. 1 shows a system diagram of the web application framework of the present invention. There are at least two HTTP or HTTPS listeners 102, each of them is waiting on a different port. The web client sends a HTTP request object 101 to the web server. The HTTP listener clones a HTTP response object into the HTTP connection object, and pass the connection object to a Security Manager 103. The security manager checks the client IP permission and URL permission based on a set of customized security rules. Then, the HTTP connection object is passed to a Web Service Entry Manager 104. The Entry Manager 104 does the class mapping work based on URL mapping rules (see the next section). Here, a web page is mapped to a class method or the web service does not exist. In the following, an Execution Engine 105 will check whether the object class is stateful or stateless.

For a stateful class, the Execution Engine 105 first check the cookie of HTTP request 101 to see whether the cookie have the following illustrative form:
SID_<ClientIP>=<web service class name>−<creationTimestamp>

If the correct cookie exists, the Execution engine 105 will use the whole cookie as a key to retrieve one class object 107 from the corresponding object pool of just mapped class inside web service object cache storage 106. If the web service class object 107 is found, then the mapped class method of this class object 107 is executed with the input parameters of HTTP request 101. The output of execution is passed back the web client via HttpResponse object 108 of the HTTP connection. After that, the web connection is closed, HttpRequest and HttpResponse objects are reclaimed, but the web service class object 107 is still stored inside the cache 106. The purge of web service object cache is managed by customized policies of cache management. If the correct cookie exists, but a web service class object 107 is not available inside the cache storage 106, a new web service class object 107 of just mapped class is created and stored into the cache storage 106 with the above cookie as the searching key. If the validated cookie does not exist in this HTTP request 101, then a new cookie with the above form will be created and assigned back to the HTTP response object 108.

For a stateless class like web calculator class, the Execution Engine 105 just does a query on the web service object cache storage 106 with a key of the following illustrative form:

SID_<business domain of web service class>_seq#=<web service class name>

Here, the business domain of web service class will be described in next section. Seq# is a sequence number (i.e., 0/1/2/ . . . ) of executing thread inside the web framework. If the web service class object 107 does not exist in the cache storage 106, then the Execution Engine 105 will create one object 107 and store it with the above no-timestamp key into the object pool of this class name inside the cache storage 106.

### Class Mapping Rules of Web Page URLs

In the present invention, the web service Entry Manager 104 maps any HTTP URL path to a class method. For a dynamic web page, a URL path except URL domain name is mapped into three components with the following illustrative form:

<Web business domain>/<full class name>/<class method name>

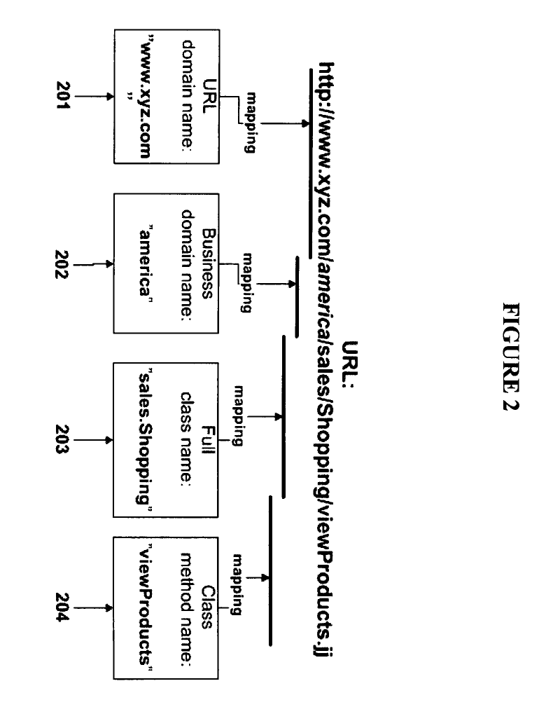

FIG. 2 shows an example of the class mapping of a dynamic web page URL path. In this example, the leftest portion is the URL domain name 201 (e.g. www.xyz.com), the left portion of the URL path is the web business domain name 202 (e.g., “america”); the last portion of the URL path is the web service class method name 204 (e.g., “viewProducts”); the intermediate portion is a full web service class name 203 after the replacement of the path separator (i.e., “/”) by the class separator (i.e., “.”). The full class name mapped is “sales.Shopping”.

For a static web page, a URL path except URL domain name is mapped into another three components with the following illustrative form:

<Web business domain>/<file location path>/<file name>

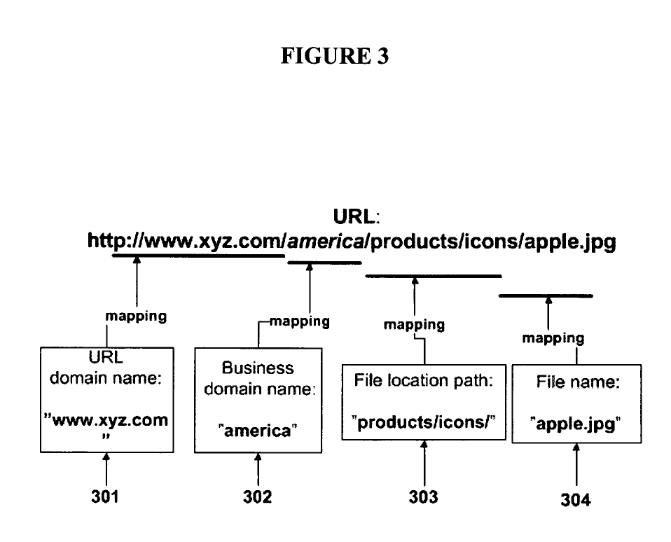

FIG. 3 shows an example of the mapping rule of a static web page URL path. In this example, the leftest portion is the URL domain name 301 (e.g. www.xyz.com), the left portion of the URL path is the web business domain name 302 (e.g., “america”); the last portion of the URL path is the file name 304 (e.g., “apple.jpg”); the intermediate portion of the URL path is the file location path 303 (e.g., “products/icons”). The absolute file path is the combination of the file base directory of this business domain and this file location path plus this file name, i.e.

<business domain file base directory>/<file location path>/<file name>

For all static web pages, the class mapping is implicit in the present invention. The mapped class is a system predefined class in a system predefined business domain. For example, the implementation of this invention can assign this system predefined class by a system variable <SYSTEM BUSINESS DOMAIN> (e.g., “shared”) and this system predefined web service class by a system variable <SYSTEM FILE LOAD> (e.g., “FileLoad”). Then, each MIME type of static web page files is mapped to one predefined method of this <SYSTEM FILE LOAD> class. For example, the image files of .jpg, .gif etc. could be mapped to a web service method of “loadImage( )” of “FileLoad” class; the text-based files of .html, .txt etc. could be mapped to a web service method of “loadText( )” of “FileLoad” class.

### Web Service Class Method and Web Service Class

A web application framework of the present invention normalizes all HTTP requests into web service class method calls of web service classes. Both web service method and web service class are defined as follows. A web service method is a class method of the unique declaration of five components in any object oriented language:

(1) modifier=“public”

(2) return type=“void”,

(3) method name=<web page name>

(4) input parameter type=“HttpRequest”

(5) output parameter type=“HttpResponse”

A web service class is a class containing at least one web service method in any object oriented language.

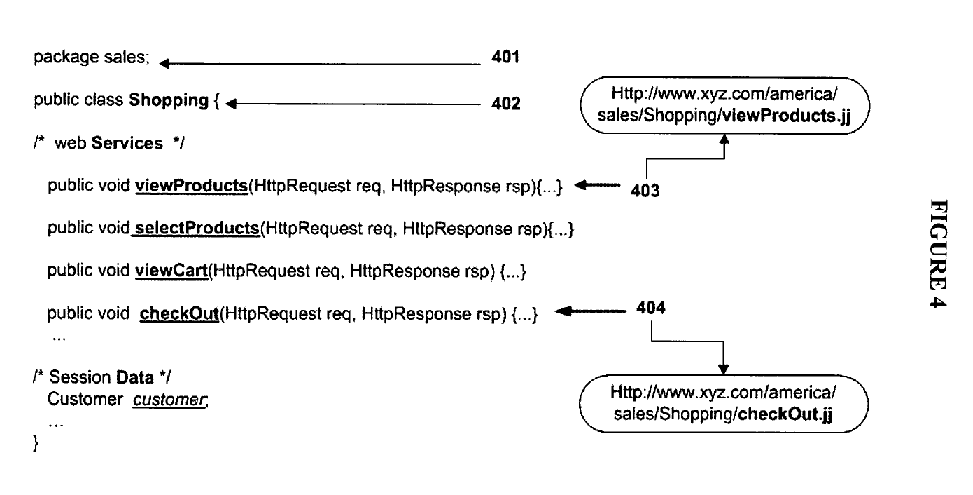

FIG. 4. shows an example of web services class of “sales.Shopping” with a few web service methods. Package name 401 (i.e., “sales”) and class name 402 (i.e., “Shopping”) constructs the full web service class name (“sales.Shopping”). The web service methods 403,404 (“viewProducts” and “checkOut”) have the following invocation signature of
public void viewProducts(HttpRequest request, HttpResponse response);
public void checkOut(HttpRequest request, HttpResponse response);

They are mapped to web page URL paths respectively as follows.
Http://www.xyz.com/america/sales/Shopping/viewProducts.jj
Http://www.xyz.com/america/sales/Shopping/checkOut.jj

According to this embodiment, the web page mapping technology of the present invention is independent of the implementation object oriented language. They could be implemented in C++, Java, C#, Python and so on.

### Web Session Management

A web framework of the present invention handles web session in an implicit way as follows:

(1) A web session is a business process containing of multiple web service requests which shares a set of variables, called session variables. Thus, a simple web session is implicitly represented by an object of the web service stateful class, which has the instance variables shared among multiple web service requests or methods. The object must be associated to web end user identification.

(2) An aggregated web session is represented by an object group of different web service stateful classes. All objects in this group have the same web end user ID.

The web end user ID is maintained by a cookie or by encoding the session ID in the URL itself. Thus, the session state actually is these session variable state of the web service class object. The lifetime of a session is the lifetime of the web service class object in the framework of this invention, because the session variables are bind with the web service class object, and the session is the natural part of the web service object. That is the big difference on the session management of this invention from all other web technologies.

Such a fundamental difference brings a set of benefits to a web framework of this invention. For examples,

(1) The maintenance of session is simple. Since the web service objects are cached, the sessions are automatically cached too.

(2) The performance of web services will be high, since the steps of web page request fulfillment is less.

(3) The application coding effort is saved, since the explicit GET/SET operations on “Session” objects are skipped.

FIG. 4 also shows that the web service class of “Shopping” is a stateful class with a session variable of “customer”. Four web services of “viewProducts, selectProducts, viewCart, checkOut” share this session variable.

### Design Paradigm of Web Service Class

Many designs of web application frameworks purely depend on a so called MVC (Model-View-Controller) architecture pattern. MVC origins from event-driven GUI applications in Smalltalk. Since HTTP is a request-response protocol, there is no defined mechanism for the web server to deliver server-side event to web clients (like browsers). Therefore, MVC is used as a way to organize web framework components into three areas (View, Model, Controller).

A web application framework of the present invention provides a natural approach of organizing the codes of a web service class into four areas, which is described by a term of “STUD”. The “STUD” is an acronym for web Services, web Templates, Utility functions and session Data.

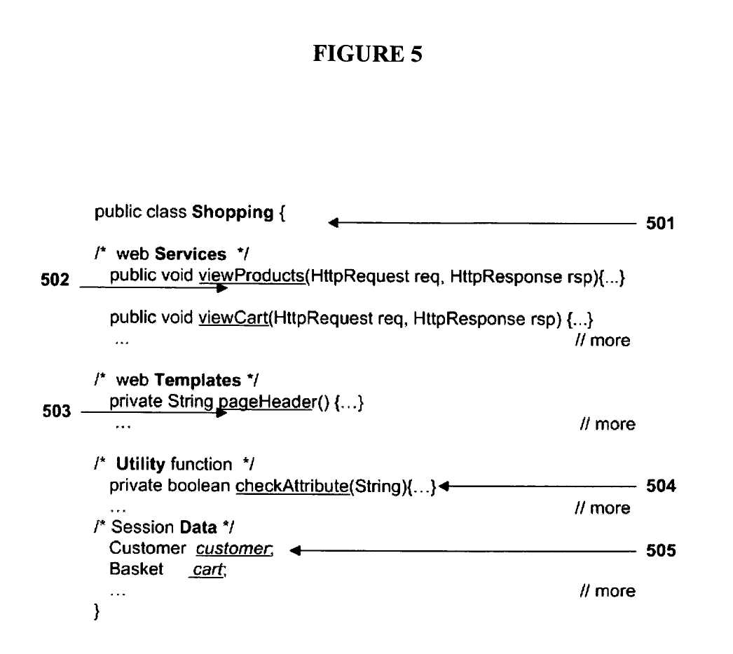

FIG. 5 illustrates an example of the design paradigm (“STUD”) of a web service class 501 (i.e., “Shopping”). The methods (“viewProducts” and “viewCart”) are web services 502. The method (“pageHeader”) is a template function 503 which returns the header html portion of the web page. The method (“checkAttribute”) is a utility function 504, which checks the incoming attribute values of HTTP request. The variable “customer” of class type <Customer> is the session data element 505.

The role of web services of a web service class is to generate the outgoing HTTP response based on the incoming HTTP request with these facilities of template functions and utility function plus the session data. One web service can be routed to another web service inside one web service object, depending on the condition of attributes in request. More generally shared web templates and web utility libraries could be coded in other classes outside this web service class.

### Persistent Data Mapping to Relational Database

Most dynamic web page creation needs data retrieval from a relational database and data storage into a relational database. Different from other object relational mapping (ORM) technology, the present invention has a few assumptions below.

(1) The database schema design is external to the web service class design, belongs to database modeling tool. Thus, all database DDL (data definition language) functions are ignored in this framework.

(2) The complex ad-hoc query with table join can be predefined by the database view or preprocessed by a database stored procedure. Thus, a web framework only needs to provide the query function on the database view and perform data manipulation on tables or materialized views.

(3) The referential integrity of persistent data records inside the web service class can be pushed to the database engine.

A web framework of the present invention maps the relational database into a three tier class structure as follows:

(1) Data record tuple of a database table is mapped to a data class inheriting the table name (i.e., class <TABLE NAME>). For example, an object of class CUSTOMERS is a holder of one data record of table CUSTOMERS in database.

(2) Database table itself is mapped to a table class inheriting the table name by appending “_TAB” (i.e., class <TABLE NAME>_TAB). The table class manages the table metadata and keeps the local cache of data record objects by option. The table class object provides a bridge for web services to interact with the database via table objects by five standard methods (i.e., select( ), update( ), delete( ), insert( ), refresh( ). For example, a class CUSTOMERS_TAB is a table bridge of CUSTOMERS.

(3) Database view is mapped to a table class too. But this table class object provides a bridge for web services to query the database only via data objects by two methods (i.e., select( ) refresh( ).

(4) Data schema is mapped to a schema class inheriting the schema name (i.e., class <SCHEMA NAME>). The schema class manages the database connection pool by the data source and controls DB transaction as well as holds a set of table class objects as well as controls the transaction operations (i.e. rollback( ) commit( ). But the schema class does not provide any database DDL (Data Definition Language) functions.

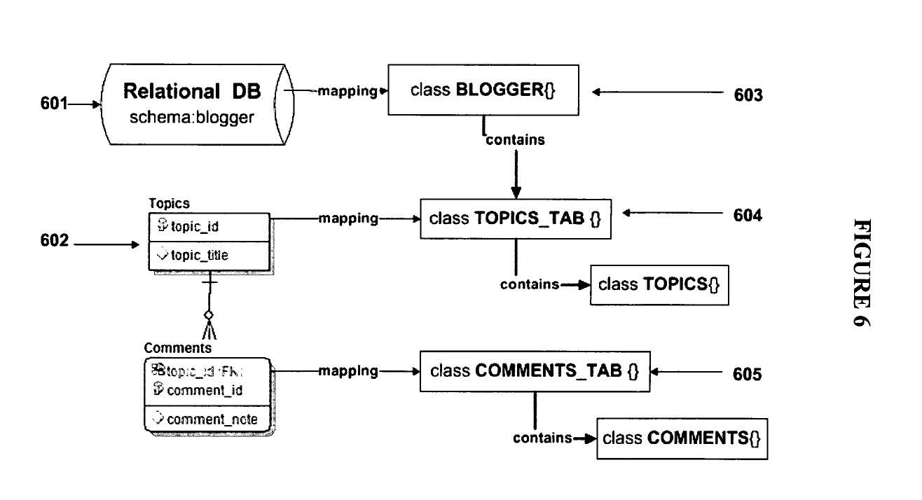

FIG. 6 shows a typical data access class mapping of a schema (“blogger”) 601 with two database tables (“topics” and “comments”) 602. There is a 1-to-many relationship from the table of “topics” to the table of “comments”. In this example, the schema (“blogger”) is mapped to “class BLOGGER” 603. The table of “topics” is mapped to two classes: “class TOPICS_TAB” and “class TOPICS” 604. The table of “comments” is mapped to two classes: “class COMMENTS_TAB” and “class COMMENTS” 605. One object of class “TOPICS” could hold all data elements of one data record in the table of “topics”. One object of class “COMMENTS” could hold all data elements of one data record in the table of “comments”.

This framework provides the main API functions of data manipulation to database by the web service classes. A general technique of QBE (Query By Example) is used to do the query via the table object

| | |
|---|---|
| BLOGGER | mydb=new BLOGGER( ); // schema object |
| TOPICS_TAB_TYPE | topics_tab=mydb.topics_tab; // table object |
| TOPICS | mytopic=new TOPICS( ); // data record object |

// set all variables in object of “mytopic”.

...

// data query

```
  topic_tab.refresh(mytopic)
  topic_tab.select(mytopic);
```

or

mytopic=topics_tab.select(“columns”,”condition”);

while(mytopic!=null){

mytopic=topics_tab.getNext( );

}

```
  //data update
  topics_tab.update(mytopic);
// data insert
```

topics_tab.insert(mytopic);

// data delete

topics_tab.delete(mytopic);

Furthermore, there are more query functions to cover the aggregation query on the database table. Also, three functions of DB transaction operations (“commit/rollback”) are defined in this framework The default setting of the auto-commit indicator of the schema object is “on”.
mydb.setAutoCommit(false);
mydb.commit( )
mydb.rollback( )

By comparison to Microsoft's LINQ (Language Integrated Query) and Java persistence API, a web application framework of the present invention will make the coding of web service class in a purely object oriented style without any SQL statement. The data manipulation on a relational database is carried out via a QBE (Query By Example) technique with a maximum simplicity. The complexity of database accessing in the web service programming is totally eliminated at the expense of some constraints of using database capability like DDL functions.

### Structured Data Object Text Format

Three major data object exchange format between web client and web server or among web servers are HTTP GET Query string, XML-based message and JSON data object. The HTTP GET Query string is not used to submit a structured data to web server. The validation of XML-based messages depends on external XML DTD files. JSON data object brings some security concern to JavaScript engine.

A web application framework of the present invention provides a new structured data object text format called “SDON”. The term of “SDON” is an acronym for Simple Data Object Notation. The MIME type of SDON data file will be “text/sdon”. The SDON filename extension is “.sdon”.

SDON includes the data type as its semantics inside itself without the loss of simplicity. A simple syntax of SDON data is “variable<DataType>={ }” for a complex structured data element. The variable name without a following angle bracket is of the basic data type (Number, String).

SDON has three basic types

(1) Number (integer or real)

(2) String (double-quoted Unicode)

(3) Object (a collection of “variable=value” pairs, semi-comma separated and enclosed in curly braces)

An Array in SDON is an ordered sequence of values, comma-separated and enclosed in square brackets. The object of “Date, Timestamp” type is represented by “String” or “Number” in SDON.

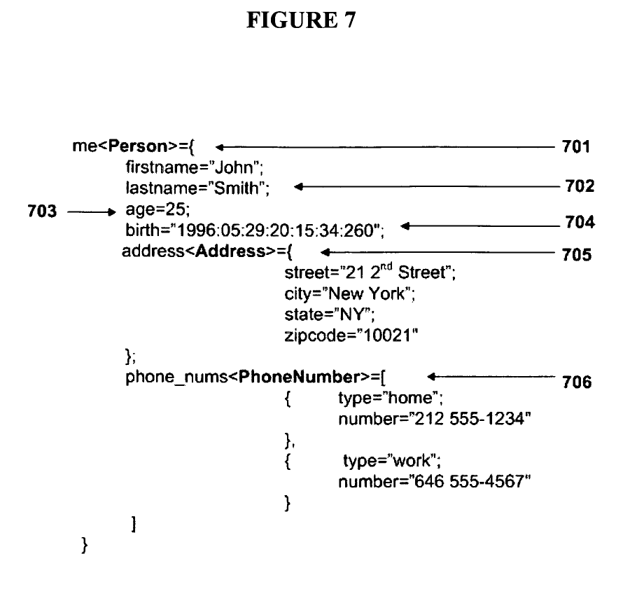

FIG. 7 shows an example of the SDON representation of a data object of class type <Person>. The variable (“me”) 701 is an object of class type <Person>. The variables (“firstname”, “lastname”) 702 are a String. The variable (“age”) 703 is a Number (mapped to “int”). The variable (“birth”) 704 is a String (mapped to “Date”). The variable (“address”) 705 is an object of class type <Address>. The variable (“phone_nums”) 706 is an object array of class type <PhoneNumber>. In this example, a SDON data object of type <Person> is mapped by three object oriented classes (Person, Address, PhoneNumber, for example, in Java) as follows:

class Person {

| | | |
|---|---|---|
| public | String | firstname; |
| public | String | lastname; |
| public | int | age; |
| public | Date | birth; |
| public | Address | address; |
| public | PhoneNumber[ ] | phone_nums; |

};
class Address {

| | | |
|---|---|---|
| public | String | street; |
| public | String | city; |
| public | String | state; |
| public | String | zipcode; |

};
class PhoneNumber {

| | | |
|---|---|---|
| public | String | type; |
| public | String | number; |

};

Although SDON looks similar to JSON in some way, SDON has a large difference from JSON in the following respects.

(1) SDON enhances its semantics by including the data object type for its complex data elements. This will greatly benefit the actual class object creation from a SDON data object by avoiding a complex external process of data validation like XML/WSDL.

(2) SDON is more consistent with the “struct” type declaration in C/C++ or Java etc. strong typed programming languages.

(3) SDON syntax of “variable=value” is consistent with the HTTP query string format, so that the data element can be directly appended to any HTTP request Query string.

(4) The variable name in SDON does not need to be double-quoted, because it will be confused with the value of String type.

While the present invention has been described and illustrated with a number of specific embodiments, the described embodiments are considered to be illustrative and not restrictive. The scope of the present invention is defined by the claims that follow.

### REFERENCES

API application programming interface
ASP active server pages
CGI common gateway interface
ColdFusion a web scripting language from Adobe
DDL data definition language of relational database
DTD document type definition
EJB enterprise java bean
Hibernate object-relational mapping library for the Java language
J2EE Java 2 enterprise edition
JDO Java data objects
JPA Java persistence API
JSF Java server Faces
JSON JavaScript simple object notation
JSP Java server pages
LINQ Language Integrated Query from Microsoft
MIME interne media type or content-type
MVC model-view-controller architecture
ODBC open database connectivity (C language)
PHP hypertext preprocessor
Python an object oriented scripting language
QBE query by example technique
SOAP simple object access protocol
STUD an acronym for service, template, utility and data
WSDL web service definition language
XML a structured data text format

I claim:

1. A method and system of building a web application framework based on mapping all web pages into object oriented classes and class methods during the receiving of client Http request calls, the system comprising:
(1) at least two HTTP listeners with HTTP protocol and HTTPS protocol;
(2) a security manager for checking the client IP permission and HTTP request URL permission;
(3) a web service entry manager for mapping the client HTTP request into an object oriented class and one class method;
(4) an execution engine for executing the class method, that is, either generating the dynamic web page content or loading a static web page file;
(5) a web service class object caching storage wherein all web service class objects are stored for query by the execution engine.

2. The method as described in claim 1 wherein a dynamic web page URL is mapped to three components (web business domain, web service class name, web service class method name);

3. The method as described in claim 1 wherein a mime type of static web page URL is mapped to three components (web business domain, file location path, file name);

4. The method as described in claim 3 wherein a further implicit mapping is done by assigning a system predefined class to be the web service class, and assigning a system predefined class method for each mime type of static web page content;

5. The method as described in claim 1 wherein a web service method of class has a fixed invocation signature of “public void <web service name>(HttpRequest, HttpResponse)”, and a web service class is a class containing at least one web service method;

6. The method as described in claim 1 wherein a web session is a business process containing multiple web service requests which are mapped to web service methods of a stateful web service class, and the web session variables are the instance data fields of a web service class;

7. The method as described in claim 6 wherein a web session lifetime is the cached web service class object lifetime controlled by the system-defined object reclaim policy;

8. The method as described in claim 6 wherein a web session must be identified by a user connection identification, represented by a HTTP cookie;

9. The method as described in claim 6 wherein an aggregated web session is a group of web service class objects sharing the same user connection ID;

10. The method as described in claim 1 wherein the cache storage of web service class objects is either a Server-tier object container or an Enterprise-tier object container;

11. A method of as described in claim 5 wherein the web service class code is organized into a paradigm of four segments, called “STUD”.

12. The method as described in claim 11 wherein the term “STUD” is an acronym for web Services, web Templates, Utility functions, session Data.

13. A method of mapping a relational database schema to a three-tier structure of data access classes in this web framework, comprising: a database connection pool management.

14. The method as described in claim 13 wherein the database schema is mapped to a class <SCHEMA NAME> with a static connection pool manager.

15. The method as described in claim 13 wherein the database table is mapped to a class <TABLE NAME>_TAB with all table data manipulation functions.

16. The method as described in claim 13 wherein the data record tuple of table is mapped to a class <TABLE NAME> to be a holder of a data record of the table.

17. The method as described in claim 15 wherein an object of class (<TABLE NAME>_TAB) is the bridge of data object interaction with the database storage management system, and is also a local cache container of data objects in this web framework.

18. A method of defining a new text format of structured data, called “SDON”, which has syntax of “variableName<Data Type>={ . . . }” and could be exchanged between the web client and web server or among web servers in this web framework.

19. The method as described in claim 18 wherein the term “SDON” is an acronym for Simple Data Object Notation.

20. The method as described in claim 18 wherein a SDON data can be reflected into an object of the data class type specified inside the SDON data itself with the advantage of data auto-validation.
